(19) United States
(12) Patent Application Publication
(10) Pub. No.: US 2023/0270134 A1
(43) Pub. Date: Aug. 31, 2023

(54) PROCESS FOR REFINING GRAINS

(71) Applicant: THE GOVERNORS OF THE UNIVERSITY OF ALBERTA, Edmonton (CA)

(72) Inventor: Thavaratnam VASANTHAN, Edmonton (CA)

(73) Assignee: THE GOVERNORS OF THE UNIVERSITY OF ALBERTA, Edmonton, AB (CA)

(21) Appl. No.: 18/005,766

(22) PCT Filed: Jul. 15, 2021
(86) PCT No.: PCT/CA2021/050980

§ 371 Date: Jan. 17, 2023

Related U.S. Application Data
(60) Provisional application No. 63/053,290, filed on Jul. 17, 2020.

(51) Int. Cl. A23J 1/14; A23L 33/185

(52) U.S. Cl. CPC A23J 1/14; A23L 33/185

(57) ABSTRACT

A process for producing a protein concentrate from grain is described. The process includes the steps of dehulling the grain to produce dehulled grain, milling the dehulled grain to produce whole grain flour, removing fiber from the whole grain flour to produce fiber-depleted flour, and removing starch from the fiber-depleted flour, thereby producing a fibre reduced protein concentrate. The protein concentrate is significantly reduced in fiber, making it suitable for further refinement via aqueous salt or alkali extraction or other purification methods.

### FIELD

The invention relates to processes for isolating proteins and other products from grain. Such proteins are used in food formulations for protein enrichment and functional properties and applications.

### BACKGROUND

The plant-based protein refining industry is experiencing significant exponential growth around the world due to fast growing consumer interest in plant protein enriched foods with a majority of the growth in North America. This is primarily due to the desire among the general population, especially in the developed nations, for clean labels, ease of digestion, the need or desire to avoid allergens, compatibility with vegetarian and vegan lifestyles and concerns about the sustainability of animal protein production. In addition, the human health benefits of consuming plant proteins, and the negative health impacts of excessive red meat consumption as well as the benefits to the environment resulting from becoming less reliant on animal-based proteins has been highlighted in many media reports. In the recent past, in response to these consumer driven trends, a wide range of food products enriched in plant proteins is emerging from the food and beverage industry.

Grains from pulse/beans, cereals and oilseeds are a good source of protein and the content ranges between 10-45% (dry basis). Such grains provide a great opportunity to refine proteins for different food and industrial applications. Grains from soy and wheat are being used by the industry to refine proteins with target functionalities, while concern over phytoestrogen content and GMO status of soy as well as the gluten intolerance (celiac disease) is growing.

Proteins from other sources, especially those from non-GMO plant sources such as pulses/beans (field pea, faba bean, lentil, mung bean, northern white bean, navy bean and black bean) are quickly gaining popularity. Protein concentrates from hemp, flax and rice are some other sources considered favorably by the supplement industries for applications related to human nutrition. Plant proteins often lack one or more amino acids which are required to meet human dietary needs, and therefore, cereal-pulse complementary combinations and amino acid supplementation can help to overcome this shortcoming in vegetarian and vegan diets.

Protein concentrates and isolates processed from these plant sources are increasingly used in food formulations not only for protein enrichment, but also for their novel functional properties to manipulate the sensory and functional dynamics of food (i.e. texture/mouth-feel/gelling/emulsion stability and flavor profile). Ingredient technologies are being developed to address the lack of texture formation and negative beany flavor in pulse protein that are considered challenges in food formulation. Meat analogs currently in the market are mainly based on soy protein concentrates or isolates that lack consumer desirability due to their GMO status, allergen concerns and off-flavors. Thus, pulse/bean proteins are quickly gaining popularity in the market since they do not suffer from these drawbacks. The development and marketing of plant proteins for use as egg replacements is also quickly growing.

There continues to be a need for improved processes of isolating plant based proteins from grain products.

### SUMMARY

According to one embodiment, there is provided a process for producing a protein concentrate or a protein isolate from a grain. The process includes the steps of dehulling the grain to produce dehulled grain; milling the dehulled grain to produce whole grain flour; removing fiber from the whole grain flour to produce fiber-depleted flour; and removing starch from the fiber-depleted flour, thereby producing the protein concentrate or the protein isolate.

The step of removing the fiber from the whole grain flour may be carried out by a dry fiber processing method.

The step of removing starch from the fiber-depleted flour may carried out by air classification.

The process may further include purifying the protein concentrate to produce the protein isolate. The purifying step may be performed by salt water extraction followed by desalting or alkali extraction followed by iso-electric precipitation.

In some embodiments, the protein concentrate with reduced fibre content is divided into: (i) a first stream of the protein concentrate which is used in the step of purifying the protein concentrate to produce the protein isolate as a first commercial product; and (ii) a second stream of the protein concentrate with reduced fibre content as a second commercial product. The first stream of the protein concentrate has a reduced material load for the step of purifying the protein concentrate, thereby increasing an economic benefit in producing the first commercial product.

In some embodiments, the first stream is between about 40% to about 60% of the protein concentrate and the second stream is a remaining portion of the protein concentrate.

The step of removing fiber from the whole grain flour may include applying the flour to a separation chamber under vacuum with vertical and horizontal airflow and a sieve, to produce the fiber-depleted flour.

The grain may be a legume pulse grain, which may be malted or sprouted. The legume pulse grain may be field pea, faba bean, lentil, mung bean, northern white bean, navy bean, or black bean.

The milling step may include dry milling performed by fluidized particle milling, hammer milling, pin milling or roller milling. The fluidized particle milling may be performed using a rotor mill.

The sieve may be provided with openings with diameters less than about 150 μm, or less than about 100 μm.

In some embodiments, the first stream of the protein concentrate has fiber content reduced by at least about 78% relative to the fiber content of the original grain weight. In other embodiments, the first stream of the protein concentrate has fiber content reduced by at least about 50%, at least about 60%, at least about 70%, at least about 75% or at least about 80% relative to the fiber content of the original grain weight.

According to another embodiment, there is provided a process for generating a plurality of streams of dietary products from a grain. The process includes the steps of dehulling the grain to produce dehulled grain; milling the dehulled grain to produce whole grain flour; removing fiber from the whole grain flour to produce a fiber concentrate in a first dietary product stream and fiber-depleted flour in a second dietary product stream; and removing starch from the fiber-depleted flour, thereby producing a protein concentrate with reduced fiber content in a third dietary product stream.

The third dietary product stream may be divided to produce a protein concentrate product stream and a protein concentrate input stream. In this embodiment, the process further comprises comprising purifying the protein concentrate input stream to produce a protein isolate as a fourth dietary product stream.

The protein concentrate product stream may be between about 40% to about 60% of the third dietary product stream and the protein concentrate input stream is a remaining portion of the second dietary product stream.

The step of dehulling may include recovering hull from the grain as a fifth dietary product stream.

The step of removing starch may include recovering the starch as an additional dietary product stream.

In some embodiments, the step of removing fiber from the whole grain flour includes applying the flour to a separation chamber under vacuum with vertical and horizontal airflow and a sieve, to produce the fiber-depleted flour.

In some embodiments, the step of removing starch from the fiber-depleted flour includes processing the fiber-depleted flour in an air classifier.

According to another embodiment, there is provided a process for producing a protein concentrate or a protein isolate from a grain. The process includes the steps of:

dehulling the grain to produce dehulled grain; milling the dehulled grain to produce whole grain flour; removing fiber from the whole grain flour to produce fiber-depleted flour using a dry processing method; and isolating protein from the fiber-depleted flour using a wet processing method, thereby producing the protein concentrate or the protein isolate.

In some embodiments, the dry processing method reduces the material load that goes into the step of isolating protein using the wet processing method.

In some embodiments, the dry processing method reduces the material load by an additional 25% relative to the quantity of the whole grain flour, thereby increasing an economic benefit of the wet processing method.

The wet processing method may be salt water extraction or alkaline extraction.

In some embodiments, the dry processing method used for the step of fiber removal is air current separation.

### BRIEF DESCRIPTION OF THE DRAWINGS

Various objects, features and advantages of the invention will be apparent from the following description of particular embodiments of the invention, as illustrated in the accompanying drawings. Emphasis is placed upon illustrating the principles of various embodiments of the invention.

FIG. 1 is a process flow diagram indicating the process of a pilot study for generating protein concentrate with dehulling, dry milling and air classification followed by aqueous extractions.

FIG. 2A is a first part of a process flow diagram (which also includes FIG. 2B) indicating one embodiment of the present technology where air current separation is implemented after dry milling to remove a significant amount of fiber from flour.

FIG. 2B is a second part of the process flow diagram (which also includes FIG. 2A) indicating that air classification followed by aqueous salt or alkali extraction is implemented after air current separation to produce a protein isolate.

FIG. 3 is a vertically integrated dry and wet process flow diagram indicating a combination of three process flows using air current separation for generating a fiber concentrate product; air classification for generating a starch concentrate product and a protein concentrate product; and a wet protein processing line for generating a protein isolate product.

FIG. 4 is a process flow diagram using conventional salt extraction in refining grains to produce protein, starch and fiber.

FIG. 5 is another process flow diagram using conventional alkaline extraction and isoelectric protein precipitation in refining grains to produce protein, starch and fiber.

### DETAILED DESCRIPTION

### Introduction and Rationale

Technologies currently available for refining plant proteins are not cost efficient. The existing amount of manufacturing is inadequate to meet demand and most of the manufacturing technologies are expensive to assemble and costly to operate. A variety of dry and wet processing technologies for refining plant proteins have been developed and currently are being used by the grain processing industry. Dry processing technologies are relatively robust and cost efficient, but result in low purity protein concentrates (less than 58%, dry basis) with inferior functional properties. As used herein, the term “dry processing” refers to the use of processing steps which do not include the use of water or other solvents. Wet processing technologies yield protein isolates with greater purity (greater than 90%, dry basis) and better functional properties (if proteins remain un-denatured). As used herein, the term “wet processing” refers to the use of processing steps which include the use of water or other solvents. However, there are several challenges that increase the cost of production and consequently limit the wider usage of refined protein isolates in food and industries. As used herein, the noun “isolate” refers to a product of relatively higher purity than a “concentrate” as a result of it having been processed via one or more additional refinement steps. As used herein, the noun “concentrate” refers to a product of a relatively lower purity than an “isolate” as a result of it having been processed via fewer refinement steps. As used herein a protein isolate has greater than about 80% protein and a protein concentrate has less than about 80% protein.

The shortcomings in the wet technologies are primarily attributed to: a lack of robustness and poor protein recovery due to fiber hydration and consequent high volume of water requirement at commercial scale processing; a lack of process cost efficiency due to multiple processing steps such as high shear mixing, centrifugation, membrane filtration and spray drying involving high volume water usage; a large capital cost for equipment setup; alkaline chemical usage to improve protein recovery that alters protein functionality and prevents “clean label” applications that have less environmental impact; and inferior quality of refined protein isolates due to partial or complete denaturation of proteins and loss of functionality as well as altered sensory properties (flavor, color, etc.) attributed to the impact of heat or alkaline and chemical usage during processing.

Legume pulse/bean grains are rich sources of nutritive and functional proteins (25-30%, dry weight basis). Although albumins (water soluble) and globulins (salt-water soluble) are the two dominant (>70%, w/w) types of protein in pulse grains, their proportions differ with source. Furthermore, these proteins exist in the cotyledon of the grain in tight association with other grain components such as starch, dietary fiber, fat and ash. The composition as well as the extent of associations among grain components differ with plant source. Therefore, one single protein refining approach or technology cannot be used to quantitatively and cost efficiently concentrate and isolate proteins from different pulse grains.

Pin-milling (i.e. fine grinding) and air-classification are conventional dry processing technologies that are commonly used in processes to produce protein concentrates from pulse grains such as field pea and faba beans, that are ˜58% purity and ˜33% yield based on hull-free/groat flour weight (as used herein the term “groat” refers to the hulled kernels of various cereal grains, such as oat, wheat, rye, and barley. Groats are whole grains that include the cereal germ and fiber-rich bran portion of the grain, as well as the endosperm (which is the usual product of milling). However, the challenges attributed to this technology have been overlooked for years and must be addressed. There are existing large capital/equipment and operational costs related to fine grinding of the raw material, increased fire hazards resulting from fine grinding and dust, poor functionality of protein concentrates due to contamination of finely ground dietary fiber (the total dietary fiber content of the protein concentrate tends to be above 20% because the finely ground fiber co-concentrates with protein during air classification), and a lack of demand for the byproduct (pulse starch concentrate which is obtained in bulk quantities. As used herein, the term “whole grain flour” is flour having the compositional ingredients of a pulse grain devoid of hull.

Pulse starches have a significant retrogradation capacity due to their high amylose content (>38%, w/w) that leads to hard gel formation, and thus not preferred in most food applications. Also, pulse starches show relatively high thermal stability (i.e. higher gelatinization temperatures) and amylase resistance (i.e. high in resistant starch and difficult to digest) when compared to regular corn, wheat and barley starches, and therefore are not preferred by animal feed and ethanol industries. Research is warranted to demonstrate new applications for pulse starches.

The traditional wet/water-based technologies for refining pulse proteins mostly involve chemicals in order to maximize protein recovery. In these technologies, pulse seeds are initially wet-ground in water adjusted to higher pH levels >8, by adding alkaline salts and chemicals such as sodium hydroxide (NaOH) and/or sodium carbonate (Na₂CO₃). Alkaline water is a wide spectrum solvent that can quantitatively solubilize proteins. The solubilized protein is subsequently separated by decanter centrifugation into the alkaline water (i.e. supernatant) and then recovered by iso-electric precipitation, usually at pH between 3.5-5, by adding mineral acids such as hydrochloric acid (HCl). This chemical processing is not only unsuitable for producing clean label proteins, but is not ecological due to the large amount of water used (multiple washing requirement raises sustainability concerns), the high cost of drying purified protein and a very significant effluent treatment cost (i.e. water recycling).

Water or salt-water based extraction technologies (i.e. clean label processing) are commonly used for pulse protein refining because >70% of the pulse or bean proteins belong to albumin and globulin types. Once solubilized and separated into a salt solution, the quantitative recovery of protein from the solution is achieved by the removal of salt by membrane filtration/dialysis and subsequent spray drying of the protein slurry. A laboratory trial on protein isolate production technologies, comparing alkali versus salt protocols (simulating commercial processing conditions), from whole field pea and faba bean flours, resulted in a protein recovery (original grain weight basis) efficiency as low as 55%. Although salt-based refining is preferred by the industry due to its “clean label” nature, improving the cost efficiency of this technology is important to ensure sustainability of this process.

Whole grain pulse/beans (de-hulled) are commonly used as raw-material in salt-water based technologies for protein isolate production. Since whole grain pulses are composed of 25-30% protein and 70-75% non-protein components, a significant amount of non-protein material is unnecessarily carried through the wet processing steps. This then subsequently requires a substantially greater salt water requirement for slurrying the raw-material, a larger capacity for equipment with a greater capital cost to handle bulk quantities, and a greater energy cost at each unit operation due to bulk mixing, centrifugation, dialysis, product drying and effluent handling. This unnecessarily increases the cost of production and compromises the cost efficiency of the process.

The inventor of the present technology has recognized these shortcomings in conventional processes and developed the present technology to address these problems and enhance value in processing of grains to produce dietary products. Various embodiments of the present technology will now be described with reference to the figures. Emphasis is placed on highlighting the various contributions of the components to the functionality of various aspects of the invention. A number of possible alternative features are introduced during the course of this description. It is to be understood that, according to the knowledge and judgment of persons skilled in the art, such alternative features may be substituted in various combinations to arrive at different embodiments.

Pilot Scale Aqueous Salt or Alkali Processing of Pea Protein Concentrate

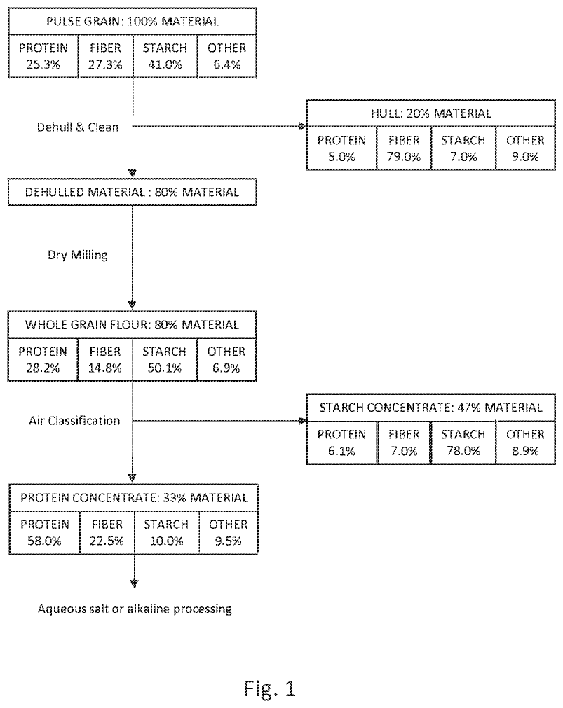

In order to address bulk handling challenges, a pilot scale aqueous salt or alkali processing trials were carried out using pea protein concentrate (produced by pin milling and air-classification) as raw-material for salt water processing. The average results in terms of yield and composition of the resulting protein product are presented in FIG. 1. Yield percentage is adjusted proportionally for the total material loss encountered during processing. Here the outcome was not promising for commercial scale-up since during processing, the viscosity/thickness of the slurry significantly increases with time and impairs the efficiency of each unit operation (including mixing, screening and centrifugation). Due to the presence of high fibre content the slurry becomes very thick and demands a high degree of dilution aqueous salt solutions or aqueous alkali solutions with additional water. The viscosity could be due to the significant total dietary fiber (TDF) content (˜22.5%, w/w) of the protein concentrate and its large hydration/water binding capacity. In addition, the dietary fiber has a very small fine particle size (<30 micro meter diameter) due to intense pin-milling, and demanded extremely fast centrifugation speeds (large g-force) in the lab centrifuge to separate the fiber from the slurry. This cannot be reliably achieved using commercial decanter centrifuges. Even with high dilution it is not feasible to produce protein isolate (>80% purity) at commercial scale because significant amounts of fine fiber particulates co-concentrate with protein. Reaching concentrations greater than 80% purity is impossible. The protein concentrate processed in the pilot trial was found to have low purity (˜69-72%, w/w, Table 1).

This pilot study confirms that intensive dry milling and particle size reduction is necessary to achieve efficient separation of starch from protein during air-classification. Such an intensive grinding, unavoidably reduce the particle size of cell wall fibres to a very fine level. During air-classification, the fine fibre unavoidably generated during intensive dry milling, co-concentrates with protein. Therefore, the protein concentrate shows high fiber content when compare to the parent material. Aqueous salt or alkaline processing is not feasible at commercial scale due to high fiber content of the input material (protein concentrate) and the resulting high viscosity of the slurry during water based wet processing. In addition, the hydrated fine fiber that co-concentrates with protein fraction will not permit recovery of more than 80% protein content in the protein isolate.

Based on this outcome, it was concluded that a pulse protein concentrate with a low TDF content would benefit the process, and would be necessary as an input for salt water-based protein extraction in order to avoid these technical challenges. With the recognition of this problem, research was initiated to reduce the dietary fiber contamination into the protein concentrate which is present when the protein concentrate is produced by a sequence of milling and air classification (as shown in FIG. 1).

### Process for Producing Commercial Scale Quantities of Proteins From Grain

Application of Air Current Assisted Particle Separation—This section describes a process for producing high quality protein from grains at commercial scale. In some embodiments, the grain process is a legume. As used herein the term “legume” refers to a plant in the family Fabaceae or Leguminosae, or the fruit or seed of such a plant (the latter which is also called a “pulse.” Legumes are grown agriculturally, primarily for human consumption, for livestock forage and silage, and as soil-enhancing green manure. Well-known legumes include peas (such as field pea), beans (such as faba bean, mung bean, northern white bean, soybean, navy bean, and black bean), alfalfa, clover, chickpeas, lentils, lupins, mesquite, carob, soybeans, peanuts, and tamarind. In some embodiments of the process the grain is a cereal grain. As used herein, the term “cereal grain” refers to the seeds that come from grasses such as wheat, millet, rice, barley, oats, rye, triticale, sorghum, and maize (corn). Oilseed crops are also a significant source of protein. As used herein, the term “oilseed” refers to seeds which are grown primarily for the oil contained in the seeds. The oil content of small grains such as wheat is only 1-2%, while for oilseeds, oil content ranges from about 20% for soybeans to over 40% for sunflowers and rapeseed (canola). The major world sources of edible seed oils are soybeans, sunflowers, rapeseed, cotton and peanuts.

With the recognition that significant quantities of dietary fiber in protein concentrate cause significant problems in subsequent protein extraction steps, the inventor recognized that removal of the dietary fiber from the grain at an early stage of the protein refining process held the possibility to provide significant improvements in the quality of protein concentrate in some embodiments of the process.

It was further recognized that this step could be used to fractionate the flour produced by dry milling. A grain refinement technology known as air current assisted particle separation has been described in U.S. Pat. Nos. 10,046,366 and 10,413,943, each incorporated herein by reference in entirety. Air current assisted particle separation uses colliding vertical and horizontal air currents, created under vacuum to fluidize the finely ground grain flour particulates above a sieve. This leads to the separation of a coarser fibrous fraction designated herein as “fiber concentrate” from a finer flour fraction designated herein as “fiber-depleted flour”, which drops through the sieve. The fiber-depleted flour is mainly composed of starch and protein. A main objective of development of the air current assisted particle separation technology was to apply it in refinement of dietary fiber components such as beta-glucans from barley grains as a natural health product. However, the inventor has now recognized that air current assisted particle separation might be also be useful for removing dietary fiber from pulse grain flour (whole grain flour) in production of high quality protein products.

Air current assisted particle separation is performed a sieving apparatus which may be formed of food-grade stainless steel or other similar materials known to those skilled in the art. The apparatus includes a bottom chamber separated from a top chamber by a sieve. Advantageously for the purpose of fractionating grain products, the sieve has openings with diameters less than about 100 micrometers (μm). This sieve serves to fractionate a mixture of grain particles into a fine fraction (i.e. particles with smaller diameters than the diameter(s) of the sieve openings) and a coarse fraction (i.e. particles with larger diameter(s) than the diameter(s) of the sieve openings). The top chamber is provided with a cover which generally covers the entire diameter of the top chamber. The top chamber cover is provided with openings. When a milled grain product is introduced into the top chamber under vacuum horizontal air currents generated by the vacuum collide with vertical air currents pulled through the openings in the cover. This produces turbulence which fluidizes the grain particles and permits the particles of the fine fraction to pass through the sieve.

It is to be understood that air current assisted particle separation and air classification (described hereinbelow) are two separate and distinct processes. Air current assisted particle separation (also referred to herein as “air current separation”) is not to be considered as a variant of air classification.

As used herein, the term “dehulling” refers to removing the hulls (also known as husk or chaff) from beans and grains. This may be done using a machine known as a huller.

Application of Fluidized Particle Milling—With the recognition that it would be advantageous to avoid generating extra fine particles which lead to loss of material inputs and represent a fire hazard, the inventor recognized that a dry milling technique known as “fluidized particle milling” could be included in embodiments of the process. Fluidized particle milling provides reduced particle sizes while loosening the associations among grain components (starch, protein, fiber, etc.), without extensively reducing the dietary fiber into undesirable finer particles. In fluidized particle milling, the pulverizing action of a rotor mill is supplied by a rotor which spins at high speed. This rotor is supported by heavy duty bearings which are located at either end of the shaft. This provides the stability necessary for greater material loading while also extending bearing life. The bearings are out of the grinding chamber and are protected from contamination. The rotor includes top and bottom sections. The bottom section includes a fan which provides air flow for the grinding system. In addition, the fan helps to accelerate and distribute the feed material prior to the material entering the grinding chamber. The top section is the grinding part of the rotor mill. It consists of a number of rows containing grinding plates which accelerate the air causing it to react with the grooved lining of the rotor mill. This interaction creates miniature pockets of rotating air at very high velocities. This air stream causes the particles to collide with each other and disintegrate while the heat caused by the size reduction is instantly absorbed by the rapidly moving air stream. An optional dynamic air classifier can be added. Finely ground material will pass through the classifier blades to collection while larger particles will be flung outward by centrifugal force into an adjustable recycle port for regrinding. The classifier speed may be changed to control the size particles that are rejected.

Fine milling of a wide variety of materials can be accomplished by adjusting the grinding plates, the style of grinding plates, and air flow to permit the fine milling of a wide variety of materials at high production rates without the temperature rise normally associated with the grinding of fine powders. Many heat sensitive materials can be milled without cryogenic processing with a separate variable speed drive. Rotor mills can be constructed in carbon or stainless steel. Interiors can be furnished with hardened material for extended life, for grinding abrasive materials.

Application of Pin Milling—In alternative embodiments, the dry milling process is performed using a pin mill, which comminutes materials by the action of pins that repeatedly move past each other, to break up substances through repeated impact. A typical pin mill is a type of vertical shaft impactor mill and consists of two rotating discs with pins embedded on one face. The discs are arrayed parallel to each other so that the pins of one disk face those of the other. The substance to be homogenized is fed into the space between the disks and either one or both disks are rotated at high speeds.

Application of Roller Milling—In alternative embodiments, the dry milling process is performed using a roller mill, which comminutes materials without too much damage to the fibers. A typical roller mill is a type of mill consists of two rotating steel rollers with corrugated or smooth surface. The rollers are placed parallel to each other with a small clearance. The substance to be homogenized/milled is fed into the clearance space between the rollers while rotated at low to medium speeds.

Application of Hammer Milling—In alternative embodiments, the dry milling process is performed using a hammer mill. A hammer mill is essentially a steel drum containing a vertical or horizontal rotating shaft or drum on which hammers are mounted. The hammers are free to swing on the ends of the cross, or fixed to the central rotor. The rotor is spun at a high speed inside the drum while material is fed into a feed hopper. The material is impacted by the hammer bars and is thereby shredded and expelled through screens in the drum of a selected size. The hammermill can be used as a primary, secondary, or tertiary crusher.

Application of Air Classification—Certain embodiments of the process described herein employ air classification to remove starch from fiber-depleted flour. An air classifier is an industrial machine which separates materials by a combination of size, shape, and density. An air classifier operates with injection of the material stream to be sorted into a chamber which contains a column of rising air in cyclonic motion. Inside the separation chamber, air drag on the objects supplies an upward force which counteracts the force of gravity and lifts the material to be sorted up into the air. Due to the dependence of air drag on object size and shape, the objects in the moving air column are sorted vertically and can be separated in this manner. Air classifiers are commonly employed in many different types of industrial processes where a large volume of mixed materials with differing physical characteristics need to be separated quickly and efficiently. The high fibre content of protein concentrates produced by air-classification of native pulse flours limits the use of such protein concentrates as inputs in other processes involving proteins.

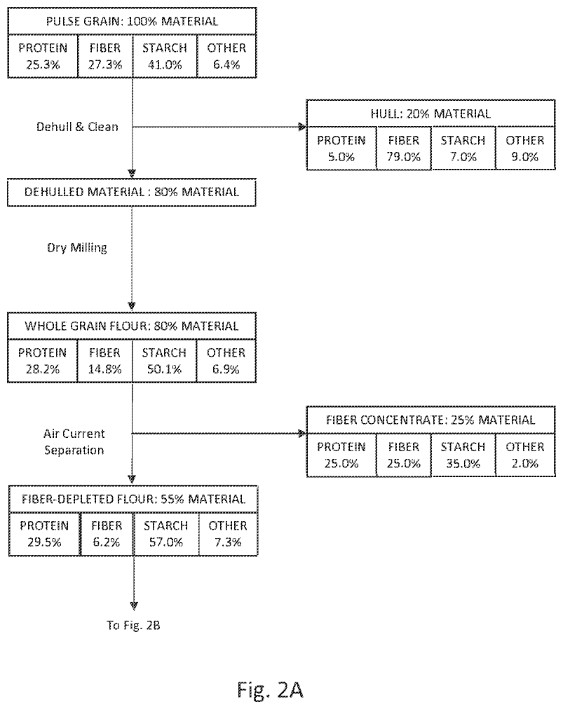

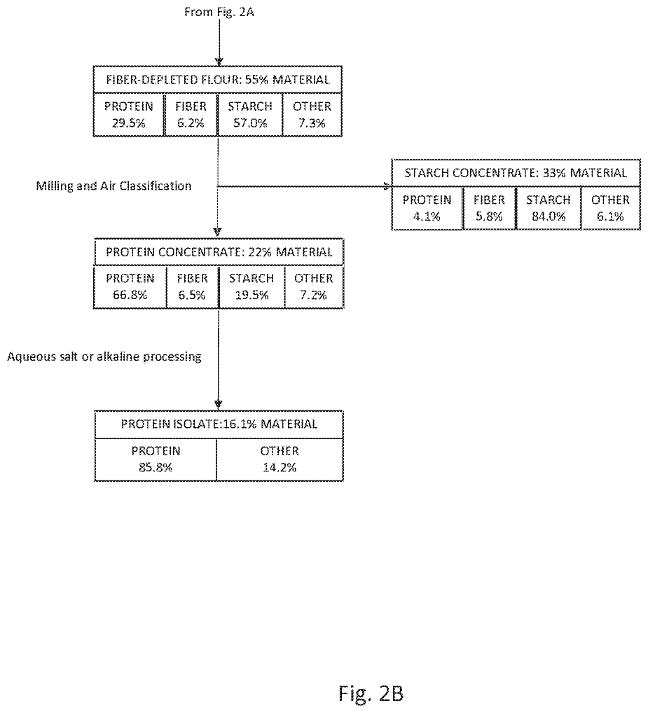

Production of Protein Isolate from Field Pea Grains—Results of application of an example process for production of protein isolate from field pea grains will now be described with respect to a flow diagram shown in FIGS. 2A and 2B. For the purpose of making a comparison of this process with the process of FIG. 1, the material compositions to the point of generation of flour after dehulling and dry milling are assumed to be identical, in order to more clearly identify the advantages provided by subsequent steps. Yield percentage is adjusted proportionally for the total material loss encountered during processing.

It is seen in FIG. 2A illustrates that the air current assisted particle separation step removed 25% material (relative to the starting material) to generate a fiber concentrate and fiber-depleted flour with a composition of 29.5% protein and 6.2% dietary fiber, thus reducing the fiber in the flour by about 58%, which is substantially lower than the fiber content in the last step in FIG. 1. In this application, milling intensity is low and optimized to avoid reduction of particle sizes of cell wall fibres to a very fine level.

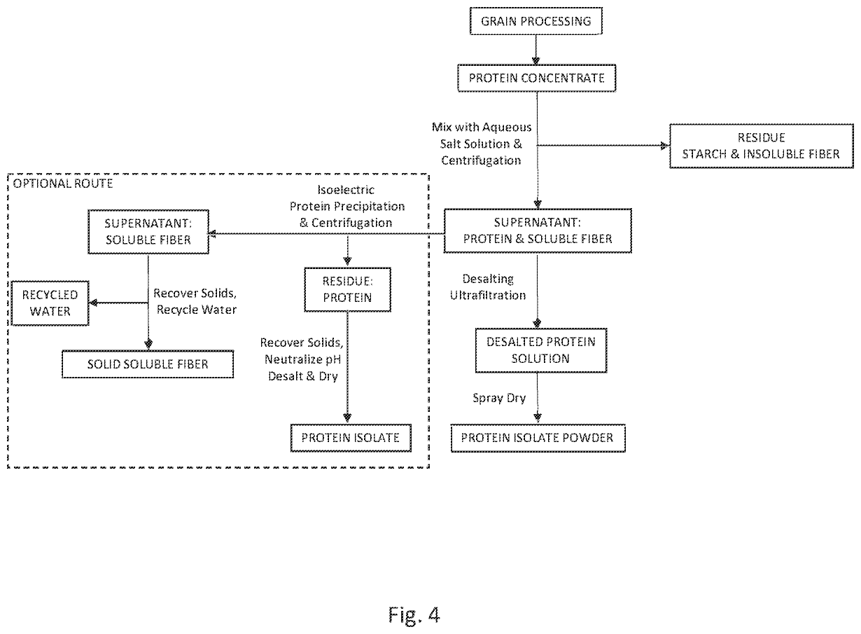

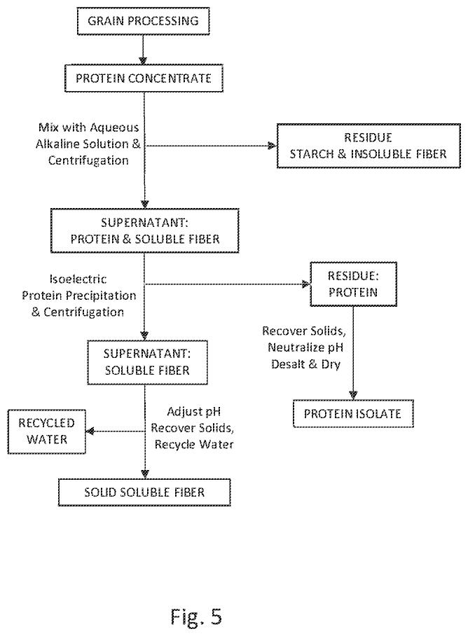

FIG. 2B indicates that the fiber-depleted flour was then air-classified into protein concentrate and starch concentrate. The protein content of the protein concentrate increased to 66.8% with reduced fiber content of 6.5%. This represents a significant improvement over the protein concentrate of the more conventional process of FIG. 1 which had 58% protein and 22.5% fiber, representing about a 70% reduction in fiber content. Therefore, the process of FIGS. 2A and 2B produces 8.8% more protein in a composition which is better suited for further purification according to traditional aqueous salt or alkali processes (FIG. 4 and FIG. 5, respectively). Therefore, the fiber depleted flour, which had ˜29.5% protein and 6.2% TDF (FIGS. 2A and 2B) represents a significantly better raw-material for input into the air-classification step relative to milled whole grain flour (hull-free) with 28.2% protein and 14.8% TDF (FIG. 1).

Further refining of the protein concentrate of FIG. 2B according to FIG. 4 or 5 yielded a protein isolate with 85.8% protein content (>90%, w/w, dry basis). Also, and very interestingly, the wet aqueous salt or alkaline processing of this protein concentrate proceeded smoothly without significant viscosity/slurry thickening challenges. This observation is believed to be due to the low fiber content of the raw material. In this approach/technology, a net protein recovery efficiency of ˜85% (based on the fiber depleted flour) is obtained only by taking ˜22% of the original grain through wet processing. A summary of these findings is presented below in Table 1. These results represent a significant technological advancement in plant protein refining.

TABLE 1
A summary of different protocols presented in FIGS. 1 and 2 for
the production of protein isolates from field pea grains through a
combination of dry and wetª isolation processes

| | | % Yield and | | | | | | |
|---|---|---|---|---|---|---|---|---|
| | | Composition of | | | | | | |
| | | the protein | | | | | | |
| | | enriched grain | % of | | | | | |
| | | material | starting | | | | | |
| | Upstream unit | produced by the | grain | | | | | |
| Starting | operations for dry | upstream dry | material | | | | | |
| grain | processing of field | processing and | taken | Field pea Protein isolateª | | | | |
| material and | pea grains prior to | subsequently | through the | Yield^{b}, Composition^{c} and Protein recovery^{d} | | | | |
| composition | wet isolationª of | taken into wet | wet | Yield | Protein | Starch | Fiber | Protein |
| (%, w/w) | protein isolate | isolationª process | processing | (%) | (%) | (%) | (%) | recovery (%) |
| Whole | De-hulling | De-hulled groats | 80 | 14-15 | 82-86 | 4-6 | 2-4 | 46 |
| yellow field | | Yield = 80% | | | | | | |
| pea | | Composition | | | | | | |
| Composition | | Protein = 28%; | | | | | | |
| Protein = | | TDF = 15%; | | | | | | |
| 25% | | Starch = 50% | | | | | | |
| TDF = 27% | | | | | | | | |
| Starch = | De-hulling, pin- | Protein | 33 | 21-23 | 69-72 | 3-4 | 18-21 | 58 |
| 41% | milling and air- | concentrate | | | | | | |
| | classification | Yield = 33% | | | | | | |
| | (FIG. 1) | Composition | | | | | | |
| | | Protein = 58%; | | | | | | |
| | | TDF = 23%; | | | | | | |
| | | Starch = 10% | | | | | | |
| | De-hulling, milling, | Protein | 22 | 15-16 | 83-86 | 4-5 | 1-2 | 55 |
| | ACAPS, pin- | concentrate | | | | | | |
| | milling and air- | Yield = 22% | | | | | | |
| | classification | Composition | | | | | | |
| | (FIG. 2) | Protein = 67%; | | | | | | |
| | | TDF = 7%; | | | | | | |
| | | Starch = 20% | | | | | | |

Values are averages of two pilot/near commercial processing trials.
^{a}Wet Isolation of field pea protein isolate according to FIG. 4 (salt extraction of protein followed by desalting by ultrafiltration to recover protein) or FIG. 5 (alkaline extraction of protein followed by isoelectric precipitation to recover protein)
^{b}% yield (w/w) is calculated based on the original grain weight basis. Not adjusted for moisture.
^{c}% composition calculated on the “as is” basis.
^{d}% protein recovery is calculated based on the protein content of the starting grain material. Not adjusted for moisture.

Integrated Process for Producing Fiber Concentrate, Protein Concentrate and Protein Isolate Products—The recognition that the fiber-depleted flour produced in the air current separation process represents a useful source of grain proteins led to the recognition that a dedicated air current separation line developed to produce a fiber concentrate product could be adapted to provide its byproduct, fiber-depleted flour, as an input stream for production of protein concentrate and protein isolate products.

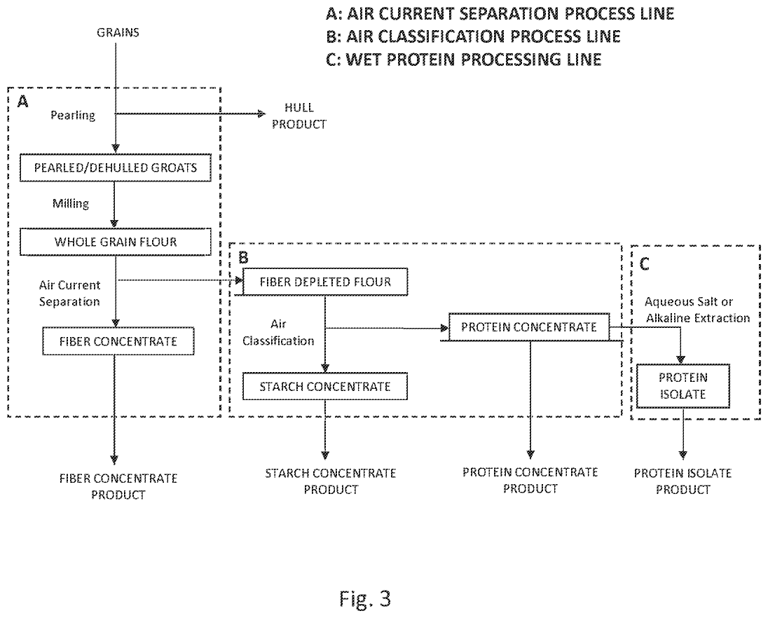

An example of such an integrated process is illustrated in FIG. 3. It is seen that process line A receives grains which are processed by pearling to provide pearled/dehulled groats, which are then dry milled to generate flour (whole grain flour). The dry milling is performed by fluidized particle milling or pin milling. The whole grain flour is then subjected to air current separation, thereby fractionating the whole grain flour into a fiber concentrate, representing a first product and fiber-depleted flour which is sent to process line B. The fiber-depleted flour is subjected to air classification, thereby generating a starch concentrate, which itself can be prepared as a starch concentrate product, and a protein concentrate, which is divided into two streams, with one stream providing a protein concentrate product and another stream being sent to a wet protein processing line C to further refine the protein into a protein isolate product.

In this manner, the byproduct of the air current separation process line is used as an input to generate highly valuable protein products as well as a starch concentrate product.

Cost Considerations—Water, natural gas and electricity consumption estimates for the production of 1 Mt of pulse protein isolate by the traditional wet fractionation process have been established as follows: water—25.04 cubic meter/Mt of isolate ($0.95/cubic m); natural gas—11.04 GJ/Mt of isolate ($2.00/GJ); and electricity—293.9 kWh/Mt of isolate ($0.10/kVVh).

Based on the estimates above 25.04 cubic meters of water is required to process 1 Mt of isolate. Therefore, a 25,000 Mt isolate production facility requires 626,000 cubic meters of water at an annual cost of $595,000 (local rates for water is used for this calculation). Because of the significant reduction in the quantity and quality (i.e. reduced fibre content) of material input in the wet processing step, this technology should reduce the water consumption by 50%. Therefore, the water consumption using our method should be 12.5 cubic m/MT of isolate. Also, the natural gas and electric usage should also be reduced by 50%. These reductions in water and energy usage make the technology more environmentally friendly and improve the long term viability of a business based on this technology.

Water used in such grain processing operations usually treated/cleaned and recycled. Therefore, if water is recycled, the low water usage in our new technology will proportionally reduce the cost of water recycling.

Assessment of Combinations of Steps in Production of Protein and Starch—Conventional processes for refinement of protein and starch from grains include steps of aqueous salt (typically NaCl) extraction or aqueous alkaline extraction followed by isoelectric precipitation. Examples of such conventional processes are illustrated in FIGS. 4 and 5, respectively.

In FIG. 4, the protein concentrate produced in grain processing (such as via FIG. 1, for example) is subjected to aqueous salt extraction (typically with about 5% NaCl) with centrifugation to produce starch and insoluble fiber as a residue and a supernatant containing protein and soluble fiber. The supernatant can be subjected to ultrafiltration for desalting, followed by spray drying to produce a protein isolate powder. As an alternative, the supernatant can be subjected to isoelectric protein precipitation (usually via pH adjustment to within a range of about 3.5 to about 4.5), and centrifugation to produce protein as a residue which can be recovered with pH adjustment to neutral, desalting and drying to produce a protein isolate. The supernatant produced in the last centrifugation step can be processed to recover solid soluble fiber and recycled water.

In FIG. 5, the protein concentrate produced in grain processing (such as via FIG. 1, for example) is subjected to aqueous alkaline extraction and centrifugation to provide starch and insoluble fiber as a residue and a supernatant which includes protein and soluble fiber. The supernatant is then subjected to isoelectric protein precipitation (usually via pH adjustment to within a range of about 3.5 to about 4.5), and centrifugation to produce protein as a residue which can be recovered with pH adjustment to neutral, desalting and drying to produce a protein isolate. The supernatant produced in the last centrifugation step can be processed to recover solid soluble fiber and recycled water.

Advantages of the Described Embodiments—Using a fiber-depleted pulse flour or a protein concentrate produced thereof having reduced fibre content as input material to produce protein isolate by an aqueous wet processing technique will provide input material with low slurry viscosity upon mixing with water. This has the advantage of requiring less water for processing while yielding equal or higher amount of protein isolate relative to using whole grain flour or protein concentrate produced from a whole grain flour as input material. In addition, there is a significant reduction in the weight of input material taken through the aqueous wet processing to produce protein isolate from a fiber depleted pulse flour or a protein concentrate produced thereof. The yield of protein isolate is equal or higher relative to using whole grain pulse flour or protein concentrate produced from whole grain pulse flour as input material. These advantages significantly improve the process economics of a pulse protein refining operation.

### Equivalents and Scope

Other than described herein, or unless otherwise expressly specified, all of the numerical ranges, amounts, values and percentages in the specification and attached claims may be read as if prefaced by the word “about” even though the term “about” may not expressly appear with the value, amount, or range. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Any patent, publication, internet site, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Unless otherwise defined, all technical and scientific terms used herein have the same meaning as commonly understood by one of ordinary skill in the art to which this invention belongs.

While this invention has been particularly shown and described with references to embodiments thereof, it will be understood by those skilled in the art that various changes in form and details may be made therein without departing from the scope of the invention encompassed by the appended claims.

In the claims, articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context.

It is also noted that the term “comprising” is intended to be open and permits but does not require the inclusion of additional elements or steps. When the term “comprising” is used herein, the term “consisting of” is thus also encompassed and disclosed. Where ranges are given, endpoints are included. Furthermore, it is to be understood that unless otherwise indicated or otherwise evident from the context and understanding of one of ordinary skill in the art, values that are expressed as ranges can assume any specific value or subrange within the stated ranges in different embodiments of the invention, to the tenth of the unit of the lower limit of the range, unless the context clearly dictates otherwise. Where the term “about” is used, it is understood to reflect+/−10% of the recited value. In addition, it is to be understood that any particular embodiment of the present invention that falls within the prior art may be explicitly excluded from any one or more of the claims. Since such embodiments are deemed to be known to one of ordinary skill in the art, they may be excluded even if the exclusion is not set forth explicitly herein.

1. A process for producing a protein concentrate or a protein isolate from a grain, the process comprising:
dehulling the grain to produce dehulled grain;
milling the dehulled grain to produce whole grain flour;
removing fiber from the whole grain flour to produce fiber-depleted flour; and
removing starch from the fiber-depleted flour, thereby producing the protein concentrate or the protein isolate.

2. The process of claim 1, wherein the step of removing the fiber from the whole grain flour is carried out by a dry fiber processing method.

3. The process of claim 1, wherein the step of removing starch from the fiber-depleted flour is carried out by air classification.

4. The process of claim 1, further comprising purifying the protein concentrate to produce the protein isolate.

5. The process of claim 4, wherein the purifying step is performed by salt water extraction followed by desalting or alkali extraction followed by iso-electric precipitation.

6. The process of claim 1, wherein the protein concentrate with reduced fibre content is divided into: (i) a first stream of the protein concentrate, the first stream used in the step of purifying the protein concentrate to produce the protein isolate as a first commercial product; and (ii) a second stream of the protein concentrate with reduced fibre content as a second commercial product, wherein the first stream of the protein concentrate has a reduced material load for the step of purifying the protein concentrate, thereby increasing an economic benefit in producing the first commercial product.

7. The process of claim 6, wherein the first stream is between about 40% to about 60% of the protein concentrate and the second stream is a remaining portion of the protein concentrate.

8. The process of claim 1, wherein the step of removing fiber from the whole grain flour comprises applying the flour to a separation chamber under vacuum with vertical and horizontal airflow and a sieve, to produce the fiber-depleted flour.

9. The process of claim 1, wherein the grain is a legume pulse grain.

10. The process of claim 9, wherein the legume pulse grain is malted or sprouted.

11. The process of claim 9, wherein the pulse grain is field pea, faba bean, lentil, mung bean, northern white bean, navy bean, or black bean.

12. The process of claim 1, wherein the milling step comprises thy milling performed by fluidized particle milling, hammer milling, pin milling or roller milling.

13. (canceled)

14. The process of claim 7, wherein the sieve has openings with diameters less than about 150 μm or less than about 100 μm.

15. (canceled)

16. The process of claim 6, wherein the first stream of the protein concentrate has fiber content reduced by at least about 78% relative to the fiber content of the original grain weight.

17. The process of claim 6, wherein the first stream of the protein concentrate has fiber content reduced by at least about 50%, at least about 60%, at least about 70%, at least about 75% or at least about 80% relative to the fiber content of the original grain weight.

18. A process for generating a plurality of streams of dietary products from a grain, the process comprising:
dehulling the grain to produce dehulled grain;
milling the dehulled grain to produce whole grain flour;
removing fiber from the whole grain flour to produce a fiber concentrate in a first dietary product stream and fiber-depleted flour in a second dietary product stream; and
removing starch from the fiber-depleted flour, thereby producing a protein concentrate with reduced fiber content in a third dietary product stream.

19. The process of claim 16, wherein the third dietary product stream is divided to produce a protein concentrate product stream and a protein concentrate input stream, and the process further comprises comprising purifying the protein concentrate input stream to produce a protein isolate as a fourth dietary product stream.

20. The process of claim 17, wherein the protein concentrate product stream is between about 40% to about 60% of the third dietary product stream and the protein concentrate input stream is a remaining portion of the second dietary product stream.

21. The process of claim 17, or wherein the step of dehulling comprises recovering hull from the grain as a fifth dietary product stream.

22. The process of claim 16, wherein the step of removing starch comprises recovering the starch as an additional dietary product stream.

23. The process of any one of claim 16, wherein the step of removing fiber from the whole grain flour comprises applying the flour to a separation chamber under vacuum with vertical and horizontal airflow and a sieve, to produce the fiber-depleted flour.

24. The process of any one of claim 16, wherein the step of removing starch
from the fiber-depleted flour comprises processing the fiber-depleted flour in an air classifier.

25. (canceled)

26. (canceled)

27. (canceled)

28. The process of claim 16, wherein the milling step comprises dry milling performed by fluidized particle milling, hammer milling, pin milling or roller milling.

29. (canceled)

30. The process of claim 21, wherein the sieve has openings with diameters less than about 150 μm or less than about 100 μm.

31. (canceled)

32. The process of claim 16, wherein the step of removing the starch from the fiber-depleted flour is performed by air classification.

33. A process for producing a protein concentrate or a protein isolate from a grain, the process comprising:
dehulling the grain to produce dehulled grain;
milling the dehulled grain to produce whole grain flour;
removing fiber from the whole grain flour to produce fiber-depleted flour using a dry processing method; and
isolating protein from the fiber-depleted flour using a wet processing method, thereby producing the protein concentrate or the protein isolate.

34. The process of claim 26, wherein the dry processing method reduces the material load that goes into the step of isolating protein using the wet processing method.

35. The process of claim 27, wherein the dry processing method reduces the material load by an additional 25% relative to the quantity of the whole grain flour, thereby increasing an economic benefit of the wet processing method.

36. The process of claim 26, wherein the wet processing method is salt water extraction or alkaline extraction.

37. The process of claim 26, wherein the dry processing method used for the step of fiber removal is air current separation.
